(19) United States
(12) Patent Application Publication
(10) Pub. No.: US 2024/0265109 A1
(43) Pub. Date: Aug. 8, 2024

(54) SECURE START OF A PROCESSING DEVICE

(71) Applicant: STMicroelectronics International N.V., Geneva (CH)

(72) Inventor: Gilles TROTTIER, Fay (FR)

(73) Assignee: STMicroelectronics International N.V., Geneva (CH)

(21) Appl. No.: 18/434,522

(22) Filed: Feb. 6, 2024

(30) Foreign Application Priority Data
Feb. 8, 2023 (FR) 2301188

(51) Int. Cl. G06F 21/57

(52) U.S. Cl. CPC G06F 21/575; G06F 2221/034

(57) ABSTRACT

A processor of a processing device executes a boot code to carry out a boot sequence of the processing device. The execution includes at least one verification step for verifying a proper progress of the boot sequence. When the verification step identifies an error in the progress of the boot sequence, a status value (with an indication that an error occurred during that verification step) is stored in a register of the processing device. The processing device is then reset. The register is accessible in read mode via a debugging interface of the processing device.

### PRIORITY CLAIM

This application claims the priority benefit of French Application for Patent No. 2301188, filed on Feb. 8, 2023, the content of which is hereby incorporated by reference in its entirety to the maximum extent allowable by law.

### TECHNICAL FIELD

The present disclosure generally concerns electronic devices and, in particular, a processing device and a method of starting the processing device.

### BACKGROUND

Generally, at the starting of a processing device, such as a device comprising a processor or a plurality of processors, a boot code is executed to verify, for example, the authenticity and/or the integrity of certain application codes.

For security and confidentiality reasons, the boot code is generally executed with no display of information relative to the progress of the execution, and such information is then not available for the user of the device. Thus, if an error occurs, it is not possible to understand its cause, nor even at what time the error has occurred. Similarly, when the boot code comprises the installation of application code, the installation may fail without for the user of the device being notified thereof. In the case where an error occurs during the starting of the processing device, the absence of information makes it difficult to debug the boot code. However, there exists a technical problem to allow the debugging of the boot code without comprising the security of the execution of this code.

### SUMMARY

An embodiment provides a method comprising the execution, by a processor of a processing device, of a boot code to carry out a boot sequence of the processing device, the execution comprising: at least one step of verification of a proper progress of the boot sequence; and when the at least one verification step identifies an error in the proper progress of the boot sequence, the storage of a status value in a register of the processing device and the resetting of the processing device, the register being accessible in read mode via a debugging interface of the device.

According to embodiment, the status value is coded over a plurality of bits, each bit indicating the state of an associated verification step.

According to embodiment, the boot code is configured to, after each verification step, control the programming of a bit associated with a verification step to a first value when an error has occurred during the verification step.

According to embodiment, the register forms part of a non-volatile memory, the register being accessible in read mode via the debugging interface during the execution of the boot code without other locations in the non-volatile memory being accessible via the debugging interface.

According to an embodiment, the above method further comprises: the recovery of the status value, via the debugging interface; and the debugging, by an external device, of the boot sequence based on the status value.

According to embodiment, the recovery of the status value occurs during the execution of the boot sequence.

According to embodiment, the processor is in a closed state during the boot sequence.

According to embodiment, at least one verification step, among the plurality of steps of verification of the boot code, comprises the verification of an authenticity and/or of an integrity and/or of a format of one or a plurality of application codes loaded in a first memory location.

According to embodiment, at least one verification step, among the plurality of steps of verification of the boot code, comprises the verification of an authenticity and/or of an integrity and/or of a format of one or a plurality of installation codes or of updates loaded in a second memory location.

According to embodiment, the status value is a hexadecimal value.

An embodiment provides a processing device comprising: a processor configured to perform, during the execution of a boot code in order to carry out a boot sequence of the processing device: at least one step of verification of the correct progress of the boot sequence; and when the at least one verification step identifies an error in the progress of the boot sequence, the storage of a status value in a non-volatile register of the processing device and the resetting of the processing device. The register is accessible in read mode via a debugging interface of the device.

According to embodiment, the register forms part of a non-volatile memory, the register being accessible in read mode via the debugging interface during the execution of the boot code without other locations in the non-volatile memory being accessible via the debugging interface.

According to embodiment, the register is accessible during the boot sequence via the debugging interface.

According to embodiment, the processor is in a closed state during the boot sequence.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 is a block diagram of a processing device according to embodiment of the present disclosure;

FIG. 2 is a flowchart illustrating steps of a method of execution of a boot code according to an embodiment of the present disclosure; and

FIG. 3 illustrates an example of embodiment of an interface of the processing device.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the different steps executing during a starting of a processing device are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

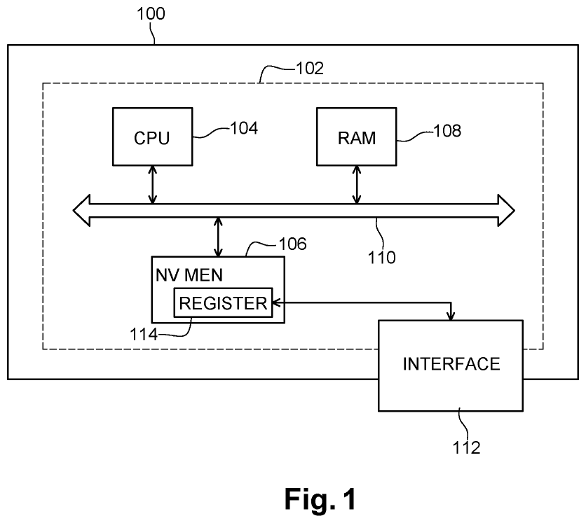

FIG. 1 is a block diagram of a processing device 100 comprising an integrated circuit 102 according to embodiment of the present disclosure.

Processing device 100 is, for example, a mobile device, such as a cell phone, or an electronic card such as a microcircuit card.

Circuit 102 comprises, for example, a processor 104 (CPU) coupled to a non-volatile memory 106 (NV MEM) and to a volatile memory 108 (RAM) via a bus 110. As an example, memory 106 is a Flash-type memory, and memory 108 is a volatile memory, for example of RAM (“Random Access Memory”) type.

The processing device further comprises, for example, a debugging interface 112 (INTERFACE). Interface 112 is, for example, an interface of JTAG (“Join Test Action Group”) type or an interface of SWD (“Serial Wire Debug”) type. Interface 112 is, for example, an interface configured to allow the access to device 100 during the execution of operations of debugging of circuit 102.

During the starting of processing device 100, a boot code, for example stored in non-volatile memory 106, is executed. The boot code enables, for example, to verify the proper operation of circuit 102 and in particular the integrity and/or the authenticity of certain application codes which are executed after the starting of processing device 100. The boot code further enables, for example, to update the application codes, for example stored in non-volatile memory 106. The boot code further allows, for example, during the starting of device 100, the installation of other application codes. As an example, during an update and/or an installation of an application code, the boot code is further configured to verify the authenticity and the integrity of the update and/or of the installed application code.

Processor 104 is locked, for example, or placed in an closed state during the execution of the boot code, for security reasons. Indeed, the execution of the boot code involves, for example, critical and/or confidential data, such as, for example, cipher keys. In particular, in the closed state, processor 104 is not accessible via interface 112. Thus, this provides a protection against attacks aiming at obtaining information relative to these critical and/or confidential data.

As an example, non-volatile memory 106 comprises a register 114 (REGISTER) coupled to interface 112. As an example, register 114 is accessible via interface 112 when the boot code is executed, without other locations in the non-volatile memory 106 being accessible via interface 112. According to embodiment, register 114 is configured, for example, to receive, for example via bus 110, indications relative to the progress of the boot code. As an example, the boot code is executed in a plurality of steps. The boot code is configured, for example, to order the storage in register 114, after at least one step, of a value of indication of the status of the execution of the boot code in register 114 indicating whether the step has succeeded or not.

According to embodiment, the indication takes the form of a field of bits. Each bit is, for example, associated with the state of a step among steps of the execution of the boot code.

As an example, a programming to value 1 of a bit of the status indication value indicates that an error has occurred during the associated step, and a programming to value 0 indicates that the associated step has occurred with no error. In another example, the programming to value 0 indicates that an error has occurred during the step and a programming to value 1 indicates that the step has occurred with no error.

As an example, the status indication value provided by register 114 to interface 112 takes the form of a hexadecimal value. The hexadecimal value encodes, for example, the information indicating which of the steps have exhibited errors and which of the steps have exhibited no errors. In another example, the indication value is a binary number having its number of bits corresponding, for example, to the number of steps during which the boot code is configured to indicate the presence of execution errors or not.

The boot code is, for example, an immutable code and is, for example, executed like a “black box”. In other words, except for what is recorded in register 114, the execution of the boot code leaves no history of the steps of its execution. As an example, when an error during the execution of the boot code occurs, an initialization of device 100 is executed, which may cause the entering into an infinite loop by the processing device. The error originates, for example, from a poor configuration of the boot code and/or from a poor ciphering of the application code to be installed or to be updated and/or from a lack of authenticity and/or of integrity of the application code and/or from a poor format in the coding of the application code, etc.

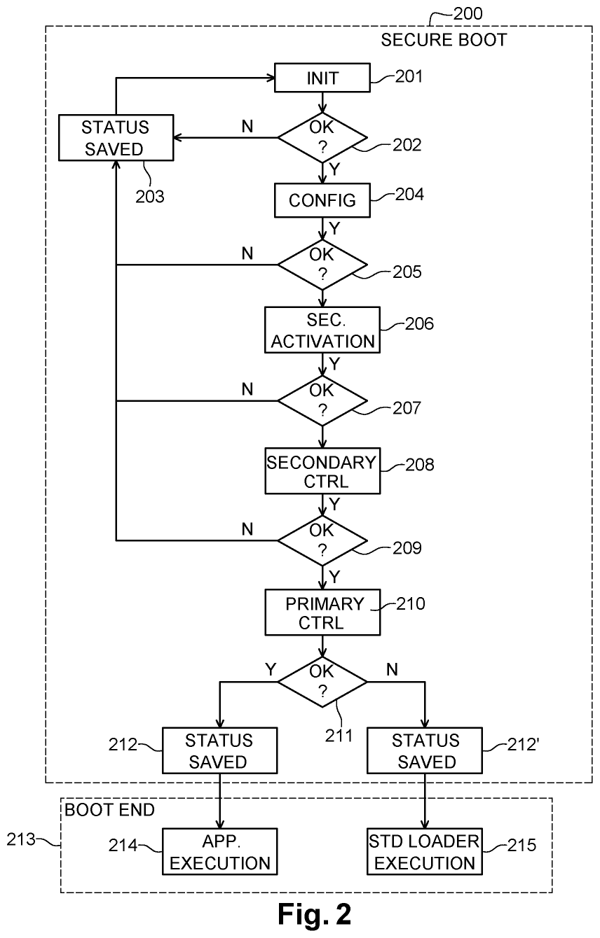

FIG. 2 is a flowchart illustrating steps of a method of execution of a boot code. This method is implemented, for example, by processor 104, under control of instructions stored in a memory of device 100, such as memory 106 or 108.

In a first phase 200 (SECURE BOOT), processing device 100 is, for example, started or reset. The boot code is then executed. First phase 200 comprises, for example, steps 201 to 212 and 212′.

At step 201 (INIT), processing device 100 is initialized. As an example, processor 104 is placed in the closed state and the boot code, as well as, for example, critical data such as cipher keys, are for example not accessible via interface 112.

It is then verified, at step 202 (OK?), whether the initialization performed at step 201 has properly occurred or not. As an example, if an error is detected during the carrying out of step 202 (branch N), the method continues at a step 203 (STATUS SAVED). As an example, an error occurs at step 201 when a cipher key is corrupt. In another example, an error during the step 201 occurs when processing device 100 is incorrectly configured and the boot code is not executed.

At step 203, the status indication value, for example stored in register 114, is updated. As an example, the bits of the status indication value are by default all programmed to value 0. After an error at step 201, the bit of the status indication value associated with initialization step 201 is, for example, programmed to value 1, indicating that an error has occurred during the carrying out of this step. In another example, the bit is, for example, left at value 0, if this value indicates an error.

After step 203, the method resumes at initialization step 201.

In the case where step 201 has successfully occurred (branch Y at the output of step 202), in other words where no error has occurred, the method continues at step 204 (CONFIG).

Step 204 is, for example, a step where the configuration of the boot code is verified. After step 204, it is verified at a new step 205 (OK?) whether verification step 204 has occurred with no error, in other words whether the configuration of the boot code has not ended successfully.

In the case where at least one error has occurred during step 204 of verification of the configuration (branch N at the output of step 205), the method continues in a carrying out of step 203. The bit of the indication value associated with the configuration verification step is then programmed to the value indicating an error.

In the case where no error has occurred during the progress of configuration verification step 204 (branch Y at the output of step 205), the method continues at a step 206 (SEC. ACTIVATION). Step 206 comprises, for example, the activation of security measures on circuit 102, and more particularly on processor 104. As an example, during step 206, a memory protection unit is activated to limit the execution of the boot code to a specific memory, for example to a memory of User Flash type contained in memory 106. As an example, during step 206, a secure access unit is activated to define and to protect secure areas of memory 106. As an example, during step 206, tamper detection mechanisms are activated to detect tampering on device 100. As an example, step 206 further comprises the verification of option bytes, for example contained in memory 108. As an example, the option bytes define a secure area and/or a non-secure area of memory 106. After step 206, it is determined, at a step 207 (OK?), whether step 206 has been correctly executed. In other words, step 207 comprises the verification of whether at least one error has occurred during the execution of step 206.

In the case where at least one error in the execution of step 206 is detected at step 207 (branch N), the method continues in a carrying out of step 203. The bit of the status indication value associated with the step of configuration of step 206 is programmed to the value indicating an error.

If, during step 207, it is determined that step 206 has occurred with no error, the method continues at a step 208 (SECONDARY CTRL). During step 208, one or a plurality of secondary memory locations, for example contained in non-volatile memory 106, are consulted. As an example, the one or a plurality of secondary memory locations are configured to store one or a plurality of codes for updating one or a plurality of application codes of processing device 100. As a variant or additionally, the one or a plurality of secondary memory locations are configured to store one or a plurality of programs of installation of one or a plurality of new application codes. In another example, the one or a plurality of secondary locations are empty, for example in the case where no application code is to be updated or to be installed. As an example, step 208 comprises verifications of the authenticity and/or of the integrity and/or of the format of the code(s) contained in the one or a plurality of secondary memory locations.

After step 208, it is determined, at step 209 (OK?), whether at least one of the verifications among those of the integrity, of the authenticity, and of the format of the application code(s) has failed. In other words, it is determined whether at least one update or installation lacks integrity and/or lacks authenticity and/or has a format problem.

If at least one of the verifications has failed during the carrying out of step 208 (branch N at the output of step 209), the method continues in a carrying out of step 203. The bit of the status indication value associated with step 208 is programmed to the value indicating an error during step 208.

In the case where the verifications of step 208 all have succeeded (branch Y at the output of step 209), the method continues at step 210 (PRIMARY CTRL). In the case where steps 208 and 209 are not carried out, step 210 follows the detection of no error during the execution of step 206.

During the carrying out of step 210, one or a plurality of primary memory locations are, for example, consulted by processor 104. As an example, the one or a plurality of primary memory locations comprise one or a plurality of application codes configured to be executed after the starting of processing device 100. As an example, step 210 comprises verifications of the authenticity and/or of the integrity and/or of the format of the code(s) contained in the one or a plurality of primary memory locations.

After step 210, at step 211 (OK?), the state of the verifications performed during the carrying out of step 210 is determined.

In the case where the verifications of step 210 have all succeeded (branch Y at the output of step 211), the method continues at step 212 (STATUS SAVED). In the opposite case, (branch N at the output of step 211), the method continues at step 212′ (STATUS SAVED).

Step 212′ comprises, for example, the programming of the bit of the status indication value associated with step 210 to the value indicating an error.

Step 212 comprises, for example, the programming of the bits associated with steps 201, 204, 206, 208, and 210 to the value indicating that no error has occurred during the carrying out of these steps. In another example, when one of steps 201, 204, 206, and 208 occurs successfully, the bit of the status indication value is directly programmed to the value indicating that no error has occurred. Thus, step 212 is similar to step 212′, with the difference that the bit is programmed to the value indicating that no error has occurred. In the example where the default value of the status indication value corresponds to the value indicating that no error has occurred during the execution of the boot code, or at least during the verified steps, step 212 is for example omitted.

As an example, the status indication value programmed during step 203, step 212 or step 212′ is equal, according to the progress of the boot sequence, to the following values programmed with the corresponding instructions:
INIT_DONE (step 201 successful)→(0x00000001UL)
CONFIG_DONE (step 204 successful)→(0x00000002UL)
SECURITY_DONE (step 206 successful)→(0x00000004UL)
SLOT_PRIMARY_1_VALID (first primary memory location valid)→(0x00000010UL)
SLOT_PRIMARY_2_VALID (second primary memory location valid)→(0x00000020UL)
SLOT_SECONDARY__1_VALID (first secondary memory location valid)→(0x00000040UL)
SLOT_SECONDARY_2_VALID (second secondary memory location valid)→(0x00000080UL)
PARSING_DONE (syntactic analysis of the code successful, carried out during step 208)→(0x00000100UL)
INSTALLATION_DONE (installation of the code successful, carried out during step 208)→(0x00000200UL)
VALIDATION_DONE (validation of the code successful, carried out during step 210)→(0x00000400UL)
JUMP_BL (instruction to jump to the boot loader successful)→(0x00001000UL)
JUMP_APPLI (instruction to jump to the application execution successful)→(0x00002000UL);
where the values are hexadecimal and letters “UL” indicated the unsigned long format.

According to the above-defined coding, each step is associated with a corresponding bit of the status indication value, and in certain embodiments, it is possible for a plurality of bits to be programmed at once to indicate that a plurality of steps have been successful.

After the carrying out of step 212 or 212′, the method continues in a phase 213 (BOOT END). As an example, phase 213 comprises a step 214 (APP. EXECUTION) for example following step 212. Step 214 comprises, for example, the execution of the application code(s) for example contained in the other memory location. During phase 213, the user has the possibility, for example, to obtain information relative to the application codes which are being executed, which was not the case during phase 200 during the execution of the boot code.

Phase 213 further comprises a step 215 (STD LOADER EXECUTION) for example following step 212′. As an example, step 215 is carried out when an error has occurred during step 210. As an example, step 215 comprises the execution of a loader-type software code enabling to access one of or the secondary locations to load one or a plurality of new application codes therein. As an example, the software code is stored in non-volatile memory 106. As an example, the software code is stored in an area defined as non-secure of non-volatile memory 106, this area, for example, being an area reserved to the system code.

As an example, the status indication value is accessible, via interface 112 at any time in the execution of the boot code. Thus, it is possible for a user of processing device 100, for example by connecting a testing device (not illustrated) to interface 112, to recover the status indication value and to deduce therefrom during which boot step an error has occurred. Thereby, it is possible, for example, to know whether the error is linked to the configuration of the boot code. The testing device is coupled, for example, to interface 112 via connectors, and/or a wireless link.

As an example, when an error has occurred in the execution of phase 200 of the boot code, interface 112 is configured to implement a protocol enabling to extract and to recover the status indication value.

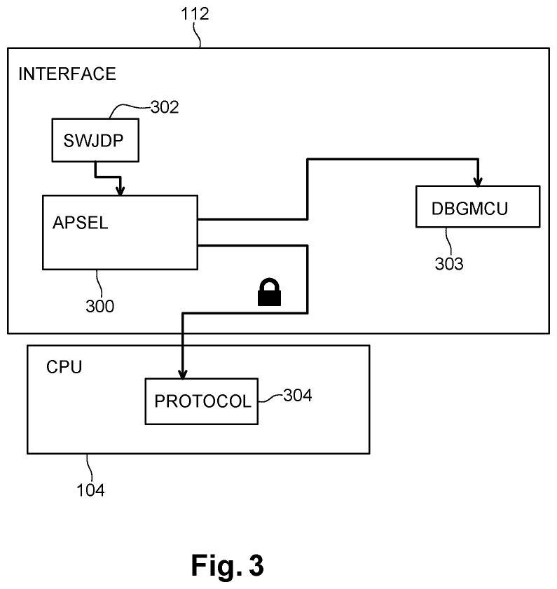

FIG. 3 illustrates, in further detail, interface 112, and more particularly, the interactions between interface 112 and processor 104.

Interface 112 comprises, for example, a register 300 (APSEL) configured to store a value, for example the value of a bit. Interface 112 further comprises, for example, a debugging port 302 (SWJPD) allowing the connection of an external testing device (not illustrated), such as a computer. As an example, port 302 is accessible via the external testing device and enables to program the value contained in register 300. Interface 112 further comprises, for example, a register 303 (DBGMCU) coupled to register 300.

Processor 104 implements, for example, a debugging protocol 304 (PROTOCOL) for application codes of device 100. As an example, this protocol 304 may be executed during the carrying out of step 214, but is not accessible during boot phase 200. In particular, processor 104 is, for example, configured to be placed in an on state from phase 213 of FIG. 2, when boot phase 200 is over. As an example, when a bit stored in register 300 is programmed to value 1 by the external testing device, processor 104 is accessible for debugging via protocol 304. The example of programming of a bit to value 1 is not limiting and other programming operations of one or a plurality of bits of a data element contained in register 300 may of course be envisaged.

As an example, processor 104 is configured to be in a closed state during the execution of the boot code, and more particularly during phase 200 of the boot code. When processor 104 is in the closed state, the access to processor 104 via protocol 304 and interface 112 is locked.

During phase 200, it is possible for the external testing device, connected to interface 112 and in particular to port 302, to order the extraction of the status indication value. As an example, the status extraction control is not performed based on a certificate and/or permission. As an example, the value programmed in register 300 during phase 200 enables external testing device to access register 303 and to program a key word therein. The programming of this key word in register 303 causes, for example, a resetting of processing device 100. During the resetting, processor 104 is then configured to execute, based on the key word present in register 303, a protocol enabling the external testing device to order the extraction of the status indication value and to transmit it to the testing device.

Although the status indication value is stored in a non-volatile memory, not necessarily secure, the boot code debugging method is submitted, for example, to one or a plurality of access restrictions. As an example, a user of device 100 is capable of reading, during boot phase 200, the status indication value but not to perform the debugging of the boot code.

An advantage of the described embodiments is that they enable to provide the user of device 100 with an indication of the state of the boot procedure of device 100. Indeed, when the boot code is not correctly executed, the status indication value provides the user with the information of the step where the error has occurred.

Various embodiments and variants have been described. Those skilled in the art will understand that certain features of these various embodiments and variants may be combined, and other variants will occur to those skilled in the art. In particular, the form and the coding of the status indication value may vary. Similarly, it is possible for only some of the verification steps 204, 206, 208, 210 of FIG. 2 to be implemented, and/or other verification steps inherent to the execution of the boot code, in addition to or instead of the steps described in relation with FIG. 2, may be carried out. Those skilled in the art will be capable of selecting the steps in the execution of the boot code for which is desires to obtain a progress indication.

Finally, the practical implementation of the described embodiments and variants is within the abilities of those skilled in the art based on the functional indications given hereabove. In particular, as for the storage of the status indication value, other memories than those described in relation with FIG. 1 maybe used to store this value.

1. A method, comprising:
executing, by a processor of a processing device, a boot code to carry out a boot sequence of the processing device;
wherein executing comprises:
performing at least one verification step to verify a proper progress of the boot sequence during execution of the boot code; and
when said at least one verification step identifies an error in proper progress of the boot sequence, storing a status value in a register of the processing device and resetting of the processing device;
wherein the register is accessible in read mode via a debugging interface of the processing device to read the stored status value.

2. The method according to claim 1, wherein the status value provides an indication that an error occurred during the verification step.

3. The method according to claim 1, wherein the status value is coded over a plurality of bits, and wherein each bit indicates that an error occurred during an associated verification step.

4. The method according to claim 3, wherein the boot code is configured, after each verification step, to control programming of a bit associated with that verification step, to a first value when an error has occurred during the verification step.

5. The method according to claim 1, wherein the register forms part of a non-volatile memory, the register being accessible in read mode via the debugging interface during the execution of the boot code without other locations in the non-volatile memory being accessible via the debugging interface.

6. The method according to claim 5, further comprising:
recovering the status value via the debugging interface; and
debugging, by an external device, of the boot sequence based on the recovered status value.

7. The method according to claim 6, wherein recovering the status value occurs during the execution of the boot sequence.

8. The method according to claim 1, wherein the processor is in a closed state during the boot sequence.

9. The method according to claim 1, wherein performing the at least one verification step comprises performing a verification of an authenticity of one or a plurality of application codes loaded in a first memory location.

10. The method according to claim 1, wherein performing the at least one verification step comprises performing a verification of an integrity of one or a plurality of application codes loaded in a first memory location.

11. The method according to claim 1, wherein performing the at least one verification step comprises performing a verification of a format of one or a plurality of application codes loaded in a first memory location.

12. The method according to claim 1, wherein performing the at least one verification step comprises performing a verification of an authenticity of a format of one or a plurality of installation codes or of updates loaded into a second memory location.

13. The method according to claim 1, wherein performing the at least one verification step comprises performing a verification of an integrity of a format of one or a plurality of installation codes or of updates loaded into a second memory location.

14. The method according to claim 1, wherein performing the at least one verification step comprises performing a verification of a format of one or a plurality of installation codes or of updates loaded into a second memory location.

15. The method according to claim 1, wherein the status value is configured in hexadecimal.

16. A processing device, comprising:
a processor configured to perform, during the execution of a boot code to carry out a boot sequence of the processing device:
at least one verification step configured to verify a proper progress of the boot sequence during execution of the boot code; and
when said at least one verification step identifies an error in proper progress of the boot sequence, store a status value in a register of the processing device and reset the processing device;
wherein the register is accessible in read mode via a debugging interface of the processing device.

17. The processing device according to claim 16, wherein the status value provides an indication that an error occurred during the verification step.

18. The processing device according to claim 16, wherein the register forms part of a non-volatile memory, wherein the register is accessible in read mode via the debugging interface during the execution of the boot code without other locations in the non-volatile memory being accessible via the debugging interface.

19. The processing device according to claim 18, wherein the register is accessible during the boot sequence via the debugging interface.

20. The processing device according to claim 16, wherein the processor is in a closed state during the boot sequence.
